(19) United States
(12) Patent Application Publication
(10) Pub. No.: US 2012/0189526 A1
(43) Pub. Date: Jul. 26, 2012

(54) PROCESS AND PLANT FOR PREPARING TRICHLOROSILANE

(75) Inventors: Adolf Petrik, Freudenstadt (DE); Jochem Hahn, Rottenburg (DE); Christian Schmid, Freudenstadt (DE)

(73) Assignee: SCHMID SILICON TECHNOLOGY GMBH, Freudenstadt (DE)

(21) Appl. No.: 13/388,692

(22) PCT Filed: Aug. 2, 2010
(86) PCT No.: PCT/EP2010/061224

§ 371 Date: Apr. 10, 2012

(30) Foreign Application Priority Data
Aug. 4, 2009 (DE) 10 2009 037 155.9

(51) Int. Cl. C01B 33/107; B01J 8/26

(52) U.S. Cl. 423/342; 422/141

(57) ABSTRACT

A process for preparing trichlorosilane includes reacting silicon particles with tetrachlorosilane and hydrogen and optionally with hydrogen chloride in a fluidized-bed reactor to form a trichlorosilane-containing product gas stream, where the trichlorosilane-containing product gas stream is discharged from the reactor via an outlet preceded by at least one particle separator which selectively allows only silicon particles up to a particular maximum size to pass through and silicon particles are discharged from the reactor at preferably regular intervals or continuously via at least one further outlet without such a particle separator.

### RELATED APPLICATIONS

This is a §371 of International Application No. PCT/EP2010/061224, with an international filing date of Aug. 2, 2010 (WO 2011/015560 A1, published Feb. 10, 2011), which is based on German Patent Application No. 10 2009 037 155.9, filed Aug. 4, 2009, the subject matter of which is incorporated by reference.

### TECHNICAL FIELD

This disclosure relates to a process for preparing trichlorosilane by preferably catalytic reaction of silicon particles with tetrachlorosilane and hydrogen in a fluidized-bed reactor and also a plant in which such a process can be operated.

### BACKGROUND

As is generally known, trichlorosilane is a valuable intermediate in the production of high-purity silicon as is required for photovoltaic applications and for semiconductor technology and also in organosilicon chemistry. Thus, for example, metallurgical silicon which frequently still has a relatively high proportion of impurities can be converted into trichlorosilane which is subsequently reduced by water to produce high-purity silicon. Such a procedure is known, for example, from DE 2 919 086. As an alternative thereto, high-purity silicon can also be obtained by thermal decomposition of monosilane, as described, for example, in DE 33 11 650. The monosilane required for this purpose can in turn be obtained, in particular, by disproportionation of trichlorosilane.

The synthesis of trichlorosilane can be carried out, in particular, via two reaction routes, namely the direct reaction of metallurgical silicon with hydrogen chloride (hydrochlorination variant) and secondly by reaction of silicon tetrachloride with metallurgical silicon and hydrogen (hydrogenation variant).

The hydrogenation variant in particular is very widespread since the silicon tetrachloride required is necessarily formed as a by-product in the disproportionation of trichlorosilane to form monosilane (as in virtually all processes for preparing polysilicon). The total yield of the synthesis chain Si+SiCl₄+H₂→SiHCl₃→SiH₄+SiH₄+SiCl₄→Si can naturally be increased significantly by feeding the silicon tetrachloride formed in the disproportionation back into the reaction route.

The reaction of silicon tetrachloride with metallurgical silicon and hydrogen to form trichlorosilane is preferably carried out in fluidized-bed reactors. A suitable fluidized-bed reactor is known, for example, from DE 196 47 162. Such a reactor generally comprises a reaction space whose lower region is provided with a distributor plate via which the hydrogen gas and gaseous silicon tetrachloride can be fed into the reaction space. Silicon particles can be introduced directly via a suitable inlet into the reaction space. The silicon particles are brought into a fluidized state by the upwards-flowing gas mixture of hydrogen and gaseous silicon tetrachloride and form a fluidized bed.

The trichlorosilane (and possibly other reaction products) formed in the fluidized bed is/are generally discharged from the reactor via an outlet in the upper region of the fluidized-bed reactor. A problem here is that, particularly at high gas velocities, fine silicon particles are always carried out from the fluidized bed by the gas and leave the reactor together with the trichlorosilane-containing product gas stream. To prevent this loss from becoming excessive, fluidized-bed reactors for the synthesis of trichlorosilane are generally provided with particle separators such as cyclones. Suitable cyclones generally have a cyclone body having a gas inlet, a gas outlet, a particle gravity outlet and a particle discharge tube whose upper end communicates with the particle gravity outlet of the cyclone body. A dust funnel is usually used between the cyclone body and the particle discharge tube.

The cyclone body, the dust funnel and the particle discharge tube are generally arranged in the reaction space of the fluidized-bed reactor such that the cyclone body is located in an upper part of the reaction space, ideally above the fluidized bed formed in the reaction space. A lower part of the particle discharge tube, on the other hand, preferably projects into the fluidized bed.

In a typical operating state of such a fluidized-bed reactor, the average particle diameter of the silicon particles introduced into the reaction space is about 100 to 400 μm. However, in ongoing operation, the size of the particles decreases and particles having sizes of, for example, less than 10 μm then occur to an increasing extent. As soon as the particle size goes below a particular particle size (the precise size depends on parameters such as the density of the particles, the flow velocities in the fluidized-bed reactor, etc.), particles having such a size are entrained in the trichlorosilane-containing product gas stream and enter the cyclone body of the cyclone. Within the cyclone body, all silicon particles above a particular (generally adjustable) particle size are separated from the product gas stream and fall through the particle gravity outlet of the cyclone body into the particle discharge tube. Via this, they can be recirculated directly into the fluidized bed. On the other hand, finer particles pass through the cyclone and have to be separated off in a complicated fashion from the trichlorosilane-containing product gas stream in subsequent steps by filters or other means. [0010]A further problem which occurs in such fluidized-bed reactors is that metallurgical silicon introduced in particulate

A further problem which occurs in such fluidized-bed reactors is that metallugical silicon introduced in particulate form always has a certain proportion of “inactive” or “inert” silicon particles which react only very slowly if at all with the gaseous silicon tetrachloride and hydrogen under the reaction conditions prevailing in the fluidized-bed reactor. This is the case when, for example, a silicon particle has a strongly oxidized surface which shields the reactive parts of the particle from the vapor/gas mixture of silicon tetrachloride and hydrogen. In long-term operation, the concentration of such particles in the fluidized bed increases with time and can have a considerable influence on the efficiency of the fluidized-bed reactor concerned. It can consequently be necessary to interrupt operation of the fluidized-bed reactor at regular intervals and partly or completely replace the silicon charge present.

As an alternative, attempts were made to keep the concentration of inactive particles in the fluidized bed low by allowing more and also larger particles than would actually be necessary to leave the reactor together with the product gas stream via the particle separator located in the fluidized-bed reactor. As mentioned above, the selectivity of particle separators such as cyclones can generally be varied.

However, the outlay in the subsequent removal of the particles from the trichlorosilane-containing product gas stream increases significantly as a consequence. Furthermore, the total yield of the reaction in terms of the metallurgical silicon used naturally also decreases significantly.

It could therefore be helpful to provide a technical solution to the preparation of trichlorosilane in which the above problems do not occur or are at least largely avoided.

### SUMMARY

We provide a process for preparing trichlorosilane in which silicon particles are reacted with tetrachlorosilane and hydrogen and optionally with hydrogen chloride in a fluidized-bed reactor to form a trichlorosilane-containing product gas stream including providing the fluidized-bed reactor with at least one inlet for the tetrachlorosilane and the hydrogen and, optionally, the hydrogen chloride, at least one inlet for the silicon particles which with the tetrachlorosilane and the hydrogen form a fluidized bed and at least one outlet for the trichlorosilane-containing product gas stream which is preceded by at least one particle separator which selectively allows only silicon particles up to a particular maximum particle size to pass through, and discharging silicon particles from the reactor at regular intervals or continuously via at least one further outlet without such a particle separator.

We also provide a plant for preparing trichlorosilane including a first reactor configured as a fluidized-bed reactor for reacting silicon particles with tetrachlorosilane and hydrogen and, optionally, with hydrogen chloride to give a first trichlorosilane-containing product gas stream, a second reactor configured as a fluidized-bed reactor for reaction of silicon particles with tetrachlorosilane and hydrogen and, optionally, with hydrogen chloride to produce a second trichlorosilane-containing product gas stream, wherein the first reactor includes at least one inlet for the tetrachlorosilane and the hydrogen and, optionally, the hydrogen chloride, at least one inlet for the silicon particles, a reaction space in which the silicon particles can form a fluidized bed with the tetrachlorosilane and the hydrogen, at least one outlet for the first trichlorosilane-containing product gas stream preceded by at least one particle separator which selectively allows only silicon particles up to a particular maximum particle size to pass through, and at least one further outlet without such a particle separator via which silicon particles having sizes above the maximum particle size can also be discharged from the reactor, the second reactor includes at least one inlet for silicon particles, a reaction space in which the silicon particles can form a fluidized bed with tetrachlorosilane and hydrogen, and at least one outlet for the second trichlorosilane-containing product gas stream, and a connection between the at least the one further outlet of the first reactor and the at least one inlet for silicon particles of the second reactor via which connection the silicon particles discharged from the first reactor can be transferred into the second reactor.

### BRIEF DESCRIPTION OF THE DRAWING

FIG. 1 schematically shows the structure of a preferred example of a plant having a first fluidized-bed reactor and a second fluidized-bed reactor.

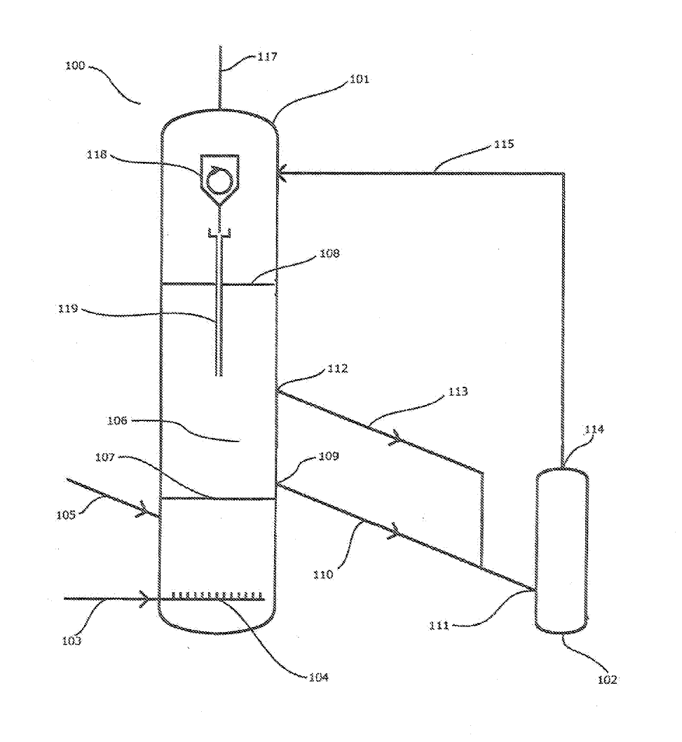

### DETAILED DESCRIPTION

Like most of the generic processes mentioned at the outset, our process makes use of a fluidized-bed reactor in which silicon particles are reacted with tetrachlorosilane and hydrogen and optionally with hydrogen chloride to form a trichlorosilane-containing product gas stream. The presence of hydrogen chloride is generally not absolutely necessary, but can have a positive effect, particularly when starting up the reactor.

The fluidized-bed reactor used has at least one inlet for the tetrachlorosilane and hydrogen, in particular a vapor/gas mixture of the two and, if appropriate, the hydrogen chloride and also at least one inlet for the silicon particles. At least the at least one inlet for the tetrachlorosilane and the hydrogen is preferably arranged in the bottom region of the fluidized-bed reactor so that the tetrachlorosilane and the hydrogen can flow upwards within the fluidized-bed reactor. Silicon particles introduced into the reactor can then form a fluidized bed with the tetrachlorosilane and the hydrogen.

Preferably, the reaction of the silicon particles with tetrachlorosilane and hydrogen and optionally with hydrogen chloride takes place under catalytic conditions. Possible catalysts are, in particular, iron- and/or copper-containing catalysts, with preference being given to using the latter. A suitable iron-containing catalyst is, for example, metallic iron, and a suitable copper-containing catalyst is metallic copper (for example, in the form of copper powder or copper flakes) or a copper compound. The catalyst can be introduced separately into the fluidized-bed reactor or be mixed beforehand with the silicon particles.

Furthermore, the fluidized-bed reactor used has at least one outlet for the trichlorosilane-containing product gas stream. As mentioned at the outset, such a trichlorosilane-containing product gas stream generally always contains small silicon particles. For this reason, at least one particle separator which selectively allows only silicon particles up to a particular maximum particle size to pass through is installed upstream of the at least one outlet for the trichlorosilane-containing product gas stream in the fluidized-bed reactor used. This maximum particle size is generally adjustable, depending on the particle separator used. Thus, the particle separator used can be, for example, a centrifugal separator, in particular a cyclone. In these separators, what particles having what size are to be separated off and what particles are allowed to pass through the separator can generally be set precisely.

In particular, our process is characterized in that silicon particles are discharged from the reactor at preferably regular intervals or continuously via at least one further outlet, where no such selectively operating particle separator is located upstream of this at least one further outlet. Accordingly, the at least one further outlet also allows silicon particles having diameters above the maximum particle size mentioned to pass through.

As mentioned at the outset, fluidized-bed reactors for preparing trichlorosilane frequently suffer from the problem that inactive silicon particles accumulate within the reactor and efficiency of the reactor is therefore reduced. The targeted discharge of silicon particles, which are generally replaced promptly by fresh silicon particles via the at least one inlet for the silicon particles, allows such accumulation of inactive particles to be effectively prevented.

The silicon particles are particularly preferably taken off directly from the fluid section of a fluidized bed in the fluidized-bed reactor. The hydrogen and the tetrachlorosilane and, if appropriate, the hydrogen chloride are preferably fed into the reactor in the bottom region of the fluidized-bed reactor. Above this bottom region, the fluidized bed is then formed. This generally has a distinct lower boundary. In the upward direction, the fluid section can have a relatively distinct boundary, particularly when the fluidized bed is a stationary fluidized bed. The fluid section of a fluidized bed is then the part between the upper boundary and the lower boundary. If, on the other hand, the fluidized bed is a circulating fluidized bed, it frequently no longer has a distinct upper boundary because of the greater flow velocities of the hydrogen and of the silicon tetrachloride and, if appropriate, of the hydrogen chloride.

Particularly preferably, the discharged silicon particles are transferred to a second reactor which is particularly preferably a second fluidized-bed reactor. There they are once again reacted with tetrachlorosilane and hydrogen and optionally with hydrogen chloride to form a trichlorosilane-containing product gas stream. In contrast to silicon particles discharged from the reactor via the outlet having the particle separator, the particles discharged in a targeted manner via the at least one further outlet are thus utilized further. This naturally makes a positive contribution to the total yield of the process.

The trichlorosilane-containing product gas stream formed in the second reactor can in principle be purified and processed further entirely separately from the product gas stream formed in the first reactor. However, particular preference is given to the trichlorosilane-containing product gas stream from the second reactor being recirculated to the upstream (first) fluidized-bed reactor. This makes it possible to keep the second reactor very simple in terms of construction. Thus, for example, no separate particle separators are required in the second reactor. Instead, the trichlorosilane-containing product gas stream from the second reactor can be combined with the trichlorosilane-containing product gas stream from the upstream fluidized-bed reactor. The combined product gas streams then pass through the at least one particle separator in the first fluidized-bed reactor.

To allow the inactive particles which are transferred from the first fluidized-bed reactor into the second reactor to also react in the latter and not accumulate there, the reaction conditions under which the discharged silicon particles are reacted in the second reactor are preferably different from those in the upstream fluidized-bed reactor. This applies particularly in respect of the reaction parameters temperature and/or pressure. Particular preference is given to the second reactor being operated at higher temperatures than the first reactor.

Furthermore, it is theoretically conceivable for the second reactor to be followed by another parallel third reactor and optionally still further reactors to prevent once again accumulation of inactive particles in the second reactor. However, this should in practice not be necessary in most cases.

Our plant for preparing trichlorosilane has a first reactor and a second reactor, in particular two fluidized-bed reactors which are each suitable for reacting silicon particles with tetrachlorosilane and hydrogen and optionally with hydrogen chloride to form a trichlorosilane-containing product gas stream. In the first reactor, a first trichlorosilane-containing product gas stream is formed and, in the second reactor, a second trichlorosilane-containing product gas stream is formed.

The first reactor preferably has at least the following components:
at least one inlet for the tetrachlorosilane and the hydrogen and if appropriate the hydrogen chloride,
at least one inlet for the silicon particles,
a reaction space in which the silicon particles can form a fluidized bed with the tetrachlorosilane and the hydrogen and, if appropriate, the hydrogen chloride,
at least one outlet for the first trichlorosilane-containing product gas stream which is preceded by at least one particle separator which selectively allows only silicon particles up to a particular maximum particle size to pass through, and
at least one further outlet without such a particle separator via which silicon particles having sizes above the maximum particle size can also be discharged from the reactor.

The second reactor comprises at least
one inlet for silicon particles,
a reaction space in which the silicon particles can form a fluidized bed with tetrachlorosilane and hydrogen and, if appropriate, with hydrogen chloride, and
at least one outlet for the second trichlorosilane-containing product gas stream.

The plant is, in particular, characterized in that there is a connection between the at least one further outlet of the first reactor and the at least one inlet for silicon particles of the second reactor, via which connection the silicon particles discharged from the first reactor can be transferred to the second reactor. Such a connection can be, for example, a pipe coupled via a suitable connecting piece such as a valve or a flap to the inlet or to the outlet of the respective reactor.

The at least one particle separator present in the first fluidized-bed reactor is preferably one or more cyclones. Suitable cyclones are known and do not have to be comprehensively explained. In addition, reference may also be made in this respect to the details given above with regard to suitable cyclones for fluidized-bed reactors.

Particularly preferably, there is at least one further connection in addition to the abovementioned connection between the first reactor and the second reactor via which further connection the second trichlorosilane-containing product gas stream can be introduced into the first reactor. In one situation having these two connections, the reaction space of the second reactor is therefore “connected in parallel” to the reaction space of the first reactor. The silicon discharged from the first reactor is reacted with silicon tetrachloride and hydrogen and optionally with hydrogen chloride in the reaction space of the second reactor, and the trichlorosilane formed is then transferred back into the first reactor, thus closing the circuit.

Further features may be derived from the following description of a preferred example of the plant. Individual features can be realized as such or in a combination of a plurality thereof. The preferred examples described are merely for the purposes of illustration and to give a better understanding and are not to be construed as constituting any restriction.

The example of a plant 100 comprises a first fluidized-bed reactor 101 and a second fluidized-bed reactor 102.

The first fluidized-bed reactor 101 has, in the bottom region, an inlet 103 via which hydrogen and gaseous silicon tetrachloride and optionally hydrogen chloride can be introduced into the reactor. Within the reactor 101, there is the distributor 104 which makes it possible to produce a uniformly distributed gas flow within the reactor. The metallurgical silicon to be reacted can be introduced via the inlet 105 into the reactor 101. This silicon forms, due to the upwards-flowing vapor/gas mixture of hydrogen and silicon tetrachloride and, if appropriate, also hydrogen chloride, a fluidized bed in the reaction space 106 of the fluidized-bed reactor 101. The fluidized bed is preferably a stationary fluidized bed, i.e., a fluidized bed which has a relatively distinct boundary both at the top and at the bottom. The lower boundary is indicated by the marking 107, and the upper boundary is indicated by the marking 108. Between the two markings is the fluid section of the fluidized bed. From this, silicon particles can be discharged from the fluidized-bed reactor 101 via the outlet 109 and be transferred via the connecting line 110 and the inlet 111 into the fluidized-bed reactor 102. Furthermore, the outlet 112 and also the connecting line 113 are also shown. These make it possible to take off silicon particles from a higher section of the fluid section of the fluidized bed. In principle, the reactor 101 can also have more than two such discharge opportunities.

In the fluidized-bed reactor 102, the discharged silicon particles can once again form a fluidized bed with hydrogen and silicon tetrachloride and optionally with hydrogen chloride (the fluidized-bed reactor 102 can for this purpose have its own inlet opportunities for hydrogen, silicon tetrachloride and hydrogen chloride). The trichlorosilane-containing reaction mixture formed here can be recirculated via the outlet 114 and the connecting line 115 to the fluidized-bed reactor 101. The mixture is preferably introduced into the reactor 101 above the upper boundary 108 of the fluidized bed. There, it can mix with the trichlorosilane-containing product mixture formed in the reactor 101.

The combined trichlorosilane-containing product mixture can be discharged from the reactor via the outlet 116 and the discharge line 117 and passed to its further use. The outlet 116 is preceded by the particle separator 118. This allows only silicon particles having a particular maximum particle size to pass through. The remaining particles are separated off within the separator 118 and recirculated via the particle gravity outlet 119 to the fluidized bed.

1. A process for preparing trichlorosilane in which silicon particles are reacted with tetrachlorosilane and hydrogen and optionally with hydrogen chloride in a fluidized-bed reactor to form a trichlorosilane-containing product gas stream comprising;
providing the fluidized-bed reactor with at least one inlet for the tetrachlorosilane and the hydrogen and, optionally, the hydrogen chloride, at least one inlet for the silicon particles which with the tetrachlorosilane and the hydrogen form a fluidized bed and at least one outlet for the trichlorosilane-containing product gas stream which is preceded by at least one particle separator which selectively allows only silicon particles up to a particular maximum particle size to pass through, and
discharging silicon particles from the reactor at regular intervals or continuously via at least one further outlet without such a particle separator.

2. the process according to claim 1, wherein the silicon particles are taken directly from the fluid section of the fluidized bed.

3. The process according to either claim 1, wherein the discharged silicon particles are transferred to a second fluidized-bed reactor where they are reacted with tetrachlorosilane and hydrogen and, optionally. with hydrogen chloride to form a second trichlorosilane-containing product gas stream.

4. The process according to claim 3, wherein the second trichlorosilane-containing product gas stream is transferred to the upstream fluidized-bed reactor having the at least one further outlet without particle separator.

5. The process according to claim 2, wherein reaction conditions in the second reactor comprising temperature arid/or pressure under which the discharged silicon particles are reacted, differ from those in the upstream fluidized-bed reactor having the at least one further outlet without particle separator.

6. A plant for preparing trichlorosilane comprising a first reactor configured as a fluidized-bed reactor for reacting silicon particles with tetrachlorosilane and hydrogen and, optionally, with hydrogen chloride to give a first trichlorosilane-containing product gas stream,
a second reactor configured as a fluidized-bed reactor for reaction of silicon particles with tetrachlorosilane and hydrogen and, optionally, with hydrogen chloride to produce a second trichlorosilane-containing product gas stream,
wherein
the first reactor comprises:
at least one inlet for the tetrachlorosilane and the hydrogen and, optionally, the hydrogen chloride,
at least one inlet for the silicon particles,
a reaction space in which the silicon particles can form a fluidized bed with the tetrachlorosilane and the hydrogen,
at least one outlet for the first trichlorosilane-containing product gas stream preceded by at least one particle separator which selectively allows only silicon particles up to a particular maximum particle size to pass through, and
at least one further outlet without such a particle separator via which silicon particles haying sizes above the maximum particle size can also be discharged from the reactor,
the second reactor comprising:
at least one inlet for silicon particles,
a reaction space in which the silicon particles can form a fluidized bed with tetrachlorosilane and hydrogen, and
at least one outlet for the second trichlorosilane-containing product gas stream, and
a connection between the at least the one further outlet of the first reactor and the at least one inlet for silicon particles of the second reactor via which connection the silicon particles discharged from the first reactor can be transferred into the second reactor.

7. The plant according to claim 6, wherein the at least one particle separator is one or more cyclones.

8. The plant according to claim 6, further comprising at least one further connection between the first reactor and the second reactor via which connection the second trichlorosilane-containing product gas stream can be introduced into the first reactor.
